(19) United States
(12) Patent Application Publication
(10) Pub. No.: US 2026/0201132 A1
(43) Pub. Date: Jul. 16, 2026

(54) METHOD FOR PREPARING THERMORESISTANT VACUUM-FORMED PLA TABLEWARE

(71) Applicant: Taizhou Corn Environmental Protection Technology Co., Ltd., Taizhou (CN)

(72) Inventors: Wenguang LI, Midlothian, VA (US); Yonglei LIU, Linyi (CN); Qizao CHEN, Taizhou (CN); Yang TAO, Taizhou (CN); Qian HU, Taizhou (CN); Yujie JIN, Taizhou (CN); Guochao HUANG, Taizhou (CN); Yuting ZHU, Taizhou (CN)

(73) Assignee: Taizhou Corn Environmental Protection Technology Co., Ltd., Taizhou (CN)

(21) Appl. No.: 18/988,901

(22) Filed: Dec. 20, 2024

Related U.S. Application Data
(63) Continuation of application No. PCT/CN2023/085173, filed on Mar. 30, 2023.

(30) Foreign Application Priority Data
Jun. 20, 2022 (CN) 202210700286.9

(51) Int. Cl. C08J 7/12; B29C 51/10; B29K 67/00; B29K 105/16; B29L 31/00; C08J 3/20; C08J 5/18; C08L 67/04

(52) U.S. Cl. CPC C08J 7/12; C08J 3/203; C08J 5/18; C08L 67/04; B29C 51/10; B29K 2067/046; B29K 2105/16; B29L 2031/7404; C08J 2367/04; C08J 2467/02; C08L 2201/08; C08L 2205/025

(57) ABSTRACT

The present application relates to the technical field of tablewares, and particularly, to a method for preparing a thermoresistant vacuum-formed PLA tableware. The method includes the following steps: preparing a sheet from a raw material of the vacuum-formed PLA tableware via extrusion using an extruder, and preparing a tableware preform from the sheet via vacuum forming, the tableware preform includes PLA that is not completely crystallized; and subjecting the tableware preform to carbon dioxide soaking treatment at constant temperature and pressure to crystallize the uncrystallized PLA in the tableware preform, so as to obtain a PLA tableware product with a thermal resistance above 100° C.

### CROSS-REFERENCE TO RELATED APPLICATIONS

The present disclosure is a continuation application of International Application No. PCT/CN2023/085173, filed on Mar. 30, 2023, which claims priority to Chinese Patent Application No. 202210700286.9, filed on Jun. 20, 2022. The disclosures of the above-mentioned applications are hereby incorporated by reference in their entireties.

### TECHNICAL FIELD

The present disclosure belongs to the technical field of tableware, and relates to a method for preparing a thermoresistant PLA vacuum-formed tableware.

### BACKGROUND

Among vacuum-formed tableware articles, there is a large group of products, such as cups, bowls, dishes, meal boxes and cup lids, which are generally prepared and produced by vacuum-forming process. The product manufacturing process is divided into two steps: firstly, the raw materials are extruded via a screw extruder to prepare a sheet and then the sheet is vacuum-formed under negative pressure or positive and negative pressure in a softened state, and then is die-cut to obtain an article. The production speed of vacuum-formed products is very fast, but there is also a very large number of leftover materials (almost half of the raw materials). In order to reduce the production cost, the leftover materials are generally returned to the previous extrusion process for reuse as a return material. However, in order to ensure that the vacuum-formed production is controllable and the product quality is stable and reliable, the proportion of the return material in the article material cannot exceed a certain limit, otherwise the performance of the final product may significantly decrease. At present, most of the vacuum-formed tableware is made of PP, PET and PS traditional plastics, and the processing performance of these plastics is relatively stable. In addition, after many years of production practice, we have found a suitable raw material formula and processing technology, and can make use of all scrap to the greatest extent as a return material without reducing the product quality. Vacuum-formed tableware products have achieved excellent performance and low price, and also meet the rapid development needs of catering industry, take-away industry and fruit and vegetable preservation industry, etc., but because they are traditional plastic articles and the waste does not degrade, serious “white pollution” has been caused. At present, the country has introduced the “Plastic Ban” to develop biodegradable products to gradually replace traditional plastic products, and control plastic pollution from the source.

Biodegradable PLA has the same performance as traditional plastic PP, so it is naturally used as a substitute product PP vacuum-formed tableware. However, due to the slow crystallization of PLA, PLA products formed by vacuum-forming are generally not thermoresistant and deform when exposed to heat. In order to produce thermoresistant PLA vacuum-formed tableware, one option is to adjust the raw material formula and the vacuum-forming process parameters to allow PLA to fully crystallize, resulting in a crystallized PLA article. However, since the crystallized PLA is not in a same state as PLA of an initial masterbatch, the crystallized leftover material cannot be used directly as a return material. This undoubtedly increases the production cost (since only half of the raw material is used) of PLA vacuum-formed product (at least twice). Another option is to subject PLA vacuum-formed product to a subsequent heat treatment crystallization to obtain a thermoresistant product; uncrystallized scrap can be used directly as return material to reduce production costs. However, vacuum-forming would generate molecular chain orientation motion, and thus internal stress may remain in the product. If heated unevenly, the product will deform. However, the general heat treatment methods (drying tunnel, oven, hot blowing, infrared heating) are neither easy to achieve accurate control nor achieve uniformity, so the quality of PLA heat treatment products is difficult to control. In addition to the high price of PLA raw material at present, the processability of PLA is not as stable as that of PP, until now, except for a small amount of PLA meal box products, other PLA vacuum-formed products are rarely seen on the market. As can be seen, it remains a challenge for the tableware industry to manufacture high quality thermoresistant PLA vacuum-formed products.

There are few research reports on PLA vacuum-formed products, and no relevant patent document has been found. At present, the research and development of PLA vacuum-formed products are mainly in two aspects. On one hand, PBS is added in the formula of PLA material, and rapid crystallization of PBS is used to support the skeleton of PLA products; the products can meet the temperature resistance requirements (70-80° C.) for general catering tableware without heat treatment. On the other hand, a high melting point, fast crystallizing PLA starting material are used to make a PLA article preform followed by a thermal drying tunnel crystallization. These two aspects are limited, the former is limited by the high price of PBS, low productivity and potential food safety hazards, and there is not large share of market for the thermoresistant PLA products; the latter is limited by the thermal drying tunnel technology, and it is not easy to manufacture thermoresistant PLA products with a stable quality.

### SUMMARY

According to the differences in the prior art, the present disclosure provides a method for preparing a thermoresistant PLA vacuum-formed tableware. The vacuum-formed PLA tableware prepared by the method provided herein has the advantages of resistance to high temperatures and thermal deformation and biodegradability, and thus represents a new generation of environment-friendly vacuum-formed tableware products.

In order to solve the above technical problem, an object of the present disclosure is achieved by the following technical solutions:

a method for preparing a thermoresistant PLA vacuum-formed tableware, which includes the following steps:
(1) preparing a sheet from a raw material of the vacuum-formed PLA tableware via extrusion using an extruder, and preparing a tableware preform from the sheet via vacuum forming, the tableware preform includes PLA that is not completely crystallized;
(2) subjecting the tableware preform to carbon dioxide soaking treatment at constant temperature and pressure to crystallize the uncrystallized PLA in the tableware preform, so as to obtain a PLA tableware product with a temperature resistance above 100° C.

In the above-mentioned method for preparing a thermoresistant PLA vacuum-formed tableware, the raw material for PLA vacuum-formed tableware in step (1) includes the following components by mass:
45%-80% of a major material;
10%-40% of an auxiliary material;
10%-35% of a filler; and
0-5% of a modifier;
where the major material is PLA;
the auxiliary material is PBAT, PBS or a blend of PBAT and PBS;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent.

The amount and type of the filler and the modifier added should not affect an effect of carbon dioxide, performance of vacuum-formed tableware and an environmentally friendly concept.

In the above-mentioned method for preparing a thermoresistant PLA vacuum-formed tableware, particles prepared by an extrusion blending and pelletizing process are used as the raw material for PLA vacuum-formed tableware in step (1).

In the above-mentioned method for preparing a thermoresistant PLA vacuum-formed tableware, where a method of the carbon dioxide soaking treatment in step (2) includes: placing PLA tableware preform in a temperature-adjustable closed container with high temperature and high-pressure resistance, injecting the carbon dioxide into the closed container, and soaking at a constant temperature and under retained pressure, quickly releasing the pressure after the soaking, opening the container, taking out the sample, and cooling at room temperature to obtain a product; and the container with high temperature and high pressure resistance is any closed container that can be temperature-adjustable and pressure resistant.

In the above-mentioned method for preparing a thermoresistant PLA vacuum-formed tableware, in step (2), a pressure retaining temperature is 35° C.-100° C., a pressure retaining pressure is 4-13 MPa, a pressure retaining time is 1-40 minutes, and a pressure release speed is 5-45 MPa/s.

In the above-mentioned method for preparing a thermoresistant PLA vacuum-formed tableware, the carbon dioxide is a supercritical carbon dioxide fluid or a subcritical carbon dioxide fluid.

In the above-mentioned method for preparing a thermoresistant PLA vacuum-formed tableware, a thickness of the sheet in step (1) is 0.35-1 mm, and thickness of the tableware preform is 0.3-0.9 mm.

The present disclosure provides two different vacuum-formed tableware products by adjusting the formula and soaking parameters. In general, the higher the pressure retaining temperature, the higher the pressure retaining pressure, the faster the pressure release speed, and the lower the density of the resulting product.

The first vacuum-formed tableware is a cup lid, and when preparing the cup lid, the vacuum-formed tableware is a cup lid, the pressure retaining temperature is 35° C.-65° C., the pressure retaining pressure is 4-7 MPa, and a density of a cup lid product relative to the preform is changed by ±1% or below; a shrinkage of the cup lid product is constant with a relative standard deviation of 0.5% or below when a sample diameter is below 100 mm, and the relative standard deviation is 1% or below when the sample diameter is 100 mm or above.

The second vacuum-formed tableware is a dish, the pressure retaining temperature is 65° C.-95° C., the pressure retaining pressure is 10-13 MPa, and a density of a dish product relative to the preform is reduced by 20%-50%.

The present disclosure has the following advantageous effects compared to the prior art.

Firstly, the present disclosure provides a method for preparing a new PLA vacuum-formed tableware. Under certain conditions of temperature and pressure, the carbon dioxide fluid can rapidly dissolve and penetrate into PLA vacuum-formed tableware, which can eliminate internal stress caused by an orientation of the vacuum-formed molecules, assist the movement of PLA macromolecular chains, and adjust spatial structure arrangement of PLA macromolecular chains without causing bending deformation of the vacuum-formed tableware, PLA can be induced to complete crystallization, and the strength and temperature resistance of PLA vacuum-formed tableware can be changed, thus fundamentally solving the problem that PLA vacuum-formed product cannot be further processed to improve the product performance; better results are obtained when supercritical fluid carbon dioxide is used as the carbon dioxide fluid.

Secondly, the present disclosure can generate micro-nano cell structure inside PLA vacuum-formed tableware through rapid pressure release and rapid gasification and expansion of carbon dioxide, so that the density of the product is reduced and the temperature resistance and heat insulation are enhanced, and in this way, PLA vacuum-formed dish can be provided with a valuable function of temperature resistance and heat insulation.

Thirdly, the process parameters of the present disclosure can be precisely controlled, and the product quality is stable; since the tableware preform is soaked in carbon dioxide, and the process parameters can be precisely controlled, there can be uniformity among and within the products, and design of the shape of the products can be unchanged. The cup lid product prepared by the present disclosure has a more precise cup lid diameter and a higher temperature resistance.

Fourthly, the production efficiency of the present disclosure is high, after using the carbon dioxide treatment technology, since it is no longer limited by whether the vacuum-formed preform is crystallized or not, the formula and composition of PLA vacuum-formed tableware can be simplified, the production cycle of vacuum-forming can be shortened, the preform is completely crystallized in the carbon dioxide soaking container for mass production, and the production efficiency of the final PLA vacuum-formed tableware product can be improved by 10% or above.

Fifthly, the present disclosure can reduce the cost, since the carbon dioxide soaking treatment of the vacuum-formed tableware can induce complete crystallization of PLA, less or no nucleating agent is used, and crystallized PLA vacuum-formed tableware can also be produced. Only one of these can reduce the costs for the raw materials by 10%. In addition, the vacuum-formed tableware can also be made into a micro-nano cell structure, thereby reducing the amount of the raw materials and the production cost of the product. In addition, the present disclosure can use PLA of a general brand, which also contributes to a reduction in the production cost of the product.

Sixthly. the present disclosure uses PLA as a major material, and the vacuum-formed tableware product thus produced is biodegradable, which not only meets our living needs, but also does not change our lifestyle and living habits, and can eliminate the environmental pollution of the traditional plastic cup lid, which will certainly have a positive social effect on the treatment of traditional plastic pollution.

At last, the present disclosure helps replacement of existing PP or PS vacuum-formed tableware with PLA vacuum-formed tableware, which reduces the difference in price between traditional vacuum-formed tableware and biodegradable vacuum-formed tableware.

### DETAILED DESCRIPTION OF THE EMBODIMENTS

The present disclosure is further illustrated by the following description of specific embodiments, which are not to be construed as limiting the present disclosure, and various modifications and improvements can be made by a person skilled in the art without departing from the basic idea of the present disclosure.

The method for determining each test data in this example is as follows.

The method for determining the density of the vacuum-formed tableware in this example is as follows.

According to the principle of Archimedes' buoyancy, by using a drainage method, samples of a vacuum-formed tableware are respectively weighed to obtain a weight in air (W₁) and a weight in water (W₂), where the difference between the weights is a buoyancy (F) experienced by the sample, which is equal to a volume of a sample (Vₛ) multiplied by density of water (d_{w}). The density (dₛ) of the sample can then be calculated.

$$F = {W}_{1} - {W}_{2} = {d}_{w} * {V}_{s}$$

$${d}_{s} = {W}_{1} / {V}_{s} = {d}_{w} * {W}_{1} / ( {W}_{1} - {W}_{2} )$$

In the example, the method for calculating the density reduction percentage of the vacuum-formed tableware is as follows:
density of the tableware preform is d₀ and density of the vacuum-formed tableware product is d_{f}, after carbon dioxide treatment, micro-nano cell structures are generated inside the vacuum-formed tableware, and the density reduction percentage X thereof is:

$$X ( \% ) = ( {d}_{0} - {d}_{f} ) / {d}_{0} * 100$$

In this example, the method for determining the temperature resistance of the vacuum-formed tableware is as follows:
an appropriate amount of distilled water is poured into a high-precision glass water bath and temperature is set (after a sample to be tested is put in, the water level should be above the tableware to be tested); when the temperature of the constant-temperature water bath reaches the required temperature, the tableware is gently clamped by tweezers and slowly put into the water (preventing from floating out of the water surface), after waiting for 20 S, it is observed that the tableware is not deformed; if the tableware is deformed, it is determined that the temperature cannot be resisted; otherwise, it is determined that the tableware can resist the temperature. The test temperature is gradually raised and the previous operation is repeated until the tableware is deformed, and the temperature before the tableware reaches this state is the highest temperature that can be resisted. When the experimental temperature reaches 100° C., the tableware can still resist temperature, the experiment can be ended, and the tableware can resist highest temperature of 100° C. or above.

The method for determining the diameter of the vacuum-formed cup lid in this example is as follows:
instrument: 400 mm digital horizontal measuring projector, model CPJ-4025W, produced by Rational Precision Instrument Co., Ltd. Test procedure: a top surface of the cup lid is fixed with a clamp, placed on the instrument measuring table, a turntable is rotated, the upper, lower, left and right of the measuring table are adjusted to make the cup lid be imaged on a screen of the projector, a focusing handle is adjusted, a focal length of the projection lens is adjusted to make the image on the screen clear, the position of the cup lid is adjusted to make the leftmost or the rightmost of the cup lid diameter coincide with the center of the projection measuring panel, X, Y and Z zero keys of an instrument operating screen are pressed, a small turntable is rotated, the left and right of the measuring table are adjusted, from the leftmost to the rightmost, from the rightmost side to the leftmost side, so that the other edge of the cup lid diameter coincides with the center of the projection measuring panel, two decimal places are reserved from the reading on the instrument operating screen, and this value is the determined value of the diameter. The cup lid is rotated, the above operation is repeated, and the determined value is recorded. General cup lid product requirements: sample diameter of 100 mm or above, range 1 mm or below, RSD of 1% or below; sample diameter below 100 mm, range of 0.5 mm or below, and RSD of 0.5% or below. In the present disclosure, a 90 cup lid (designed to have a diameter of 90 mm) is used as an experimental sample. In a batch of samples (preforms of a cup lid or cup lid products, see the definition below), 2 samples are randomly taken for testing, each sample is tested for 4 times, and the final result is averaged to calculate the relative standard deviation (RSD).

The raw material sources in the examples of the present disclosure are as shown in Table 1-1:

TABLE 1-1
Raw materials and source

| Compounds | Brand or specification | Source |
|---|---|---|
| PLA | 110 | Zhejiang Hisun |
| | | Biomaterials Co., Ltd. |
| PBAT | KHB21AP11 | Kanghui New Material |
| | | Technology Co., Ltd. |
| Talcum powder | 1250 Meshes | Commercially available |

TABLE 1-2
Raw material formula for PLA vacuum-formed tableware, cup
lid density, cup lid diameter and temperature resistance

| | | | | | | | Temper- |
|---|---|---|---|---|---|---|---|
| | | | | | Cup lid | | ature |
| Formula | PLA | PBAT | Filler | Density | diameter | RSD | resistance |
| number | (%) | (%) | (%) | (g/cm³) | (mm) | (%) | (° C.) |
| 1 | 60 | 20 | 20 | 1.385 | 88.89 | 0.25 | 55 |
| 2 | 55 | 15 | 30 | 1.474 | 88.81 | 0.21 | 55 |
| 3 | 70 | 15 | 15 | 1.360 | 88.61 | 0.34 | 55 |

The PLA vacuum-formed tableware samples are prepared as follows in the embodiments.

### (1) Preparation of PLA Tableware Preforms:

raw material particles of PLA vacuum-formed tableware are prepared from the raw materials of PLA vacuum-formed tableware by an extrusion blending and pelletizing process. The raw material particles are then subjected to extrusion of melt, extrusion, air-forming, and rolling, etc. via a screw extruder to prepare a roll of a PLA sheet with a predetermined thickness and width. (The thicknesses of the sheet used to prepare the vacuum-formed cup lid and dish are 0.50 mm and 0.38 mm, respectively).

PLA roll is pulled and unwound, the sheet is passed through a pre-heated table, vacuum-formed molded under negative pressure, and then processed to be an article subjected to die cutting, stacking and scrap winding, and then being packaged in a box.

PLA vacuum-formed tableware prepared by extruding the raw material particles using an extruder to obtain a sheet, and then subjecting the sheet to a vacuum-forming process is referred to as a vacuum-formed tableware preform. Typically, such product is not thermoresistant (the temperature resistance is below 60° C.)

### (2) Preparation of PLA Vacuum-Formed Tableware Samples:

PLA vacuum-formed tableware preforms are soaked in a carbon dioxide closed container (mold) with constant temperature and pressure for a predetermined time, then performed rapid pressure release to open the mold, the samples are taken out and cooled at room temperature, so as to obtain the thermoresistant PLA vacuum-formed tableware product. The carbon dioxide processing conditions for PLA vacuum-formed cup lid and dish with different formulas are as shown in Tables 2 and 3, respectively.

TABLE 2
Carbon dioxide treatment processing conditions, product density, cup
lid diameter and temperature resistance of PLA vacuum-formed cup lid

| | | Pressure | | | | | | | | | |
|---|---|---|---|---|---|---|---|---|---|---|---|
| | | retaining | Pressure | Pressure | Pressure | | Density | | | Diam- | |
| Exam- | | temper- | retaining | retaining | release | Product | reduc- | Cup lid | | eter | Temperature |
| ple | For- | ature | pressure | time | speed | density | tion | diameter | RSD | change | resistance |
| # | mula # | (° C.) | (MPa) | (min) | (MPa/s) | (g/cm³) | (%) | (mm) | (%) | (%) | (° C.) |
| 1 | 1 | 45 | 4.5 | 20 | 16 | 1.389 | −0.3 | 86.91 | 0.10 | −2.23 | >100 |
| | 2 | 45 | 4.5 | 20 | 16 | 1.481 | −0.5 | 87.24 | 0.27 | −1.77 | >100 |
| | 3 | 45 | 4.5 | 20 | 16 | 1.357 | 0.2 | 86.88 | 0.24 | −1.95 | >100 |
| 2 | 1 | 65 | 4.5 | 20 | 16 | 1.390 | −0.4 | 87.06 | 0.35 | −2.06 | >100 |
| | 2 | 65 | 4.5 | 20 | 16 | 1.479 | 0.3 | 87.57 | 0.16 | −1.40 | >100 |
| | 3 | 65 | 4.5 | 20 | 16 | 1.355 | 0.4 | 87.05 | 0.39 | −1.76 | >100 |
| 3 | 1 | 55 | 4.5 | 3 | 16 | 1.392 | −0.5 | 87.15 | 0.38 | −1.96 | >100 |
| | 1 | 55 | 4.5 | 10 | 16 | 1.393 | −0.6 | 86.95 | 0.29 | −2.18 | >100 |
| | 1 | 55 | 4.5 | 20 | 16 | 1.389 | −0.3 | 86.94 | 0.35 | −2.19 | >100 |
| | 1 | 55 | 4.5 | 40 | 16 | 1.384 | 0.1 | 87.06 | 0.36 | −2.06 | >100 |
| 4 | 3 | 35 | 4 | 20 | 14 | 1.358 | 0.1 | 86.80 | 0.32 | −2.05 | >100 |
| | 3 | 35 | 7 | 20 | 24 | 1.352 | 0.6 | 86.71 | 0.20 | −2.16 | >100 |

TABLE 3
Carbon dioxide treatment processing conditions, product density
and temperature resistance of PLA vacuum-formed dish

| | | Pressure | | | | | | |
|---|---|---|---|---|---|---|---|---|
| | | retaining | Pressure | Pressure | Pressure | | | |
| Exam- | For- | temper- | retaining | retaining | release | Product | Density | Temperature |
| ple | mula | ature | pressure | time | speed | density | reduction | resistance |
| # | # | (° C.) | (MPa) | (min) | (MPa/s) | (g/cm³) | (%) | (° C.) |
| 5 | 3 | 65 | 10 | 20 | 34 | 1.084 | 20.4 | >100 |
| 6 | 3 | 75 | 13 | 20 | 44 | 0.932 | 31.6 | >100 |
| 7 | 3 | 85 | 10 | 20 | 34 | 0.882 | 35.2 | >100 |
| 8 | 3 | 95 | 12 | 6 | 41 | 0.800 | 41.3 | >100 |

### Example 1

PLA vacuum-formed cup lid preforms with formula composition Nos. 1-3 are placed in a mold container at 45° C., carbon dioxide is injected into the container at a pressure of 4.5 MPa, the preforms are soaked at constant temperature and pressure for 20 minutes, rapid pressure release at a speed of 16 MPa/s is performed, the mold is opened to take out the samples, and the samples are cooled at room temperature to obtain PLA vacuum-formed cup lid product. The samples are tested for densities, cup lid diameter and temperature resistance are tested and the results are as shown in Table 2. After carbon dioxide treatment, the densities of the samples are hardly changed, and the appearance and morphology of the samples are not apparently changed. The cup lid diameter is changed by 1.77%-2.23% due to shrinkage as compared with the cup lid preform, and the relative standard deviation is 0.10%-0.27%, but all the cup lids have a temperature resistance above 100° C.

### Example 2

PLA vacuum-formed cup lid preforms with formula composition Nos. 1-3 are placed in a mold container at 65° C., carbon dioxide is injected into the container at a pressure of 4.5 MPa, the preforms are soaked at constant temperature and pressure for 20 minutes, rapid pressure release at a speed of 16 MPa/s is performed, the mold is opened to take out the samples, and the samples are cooled at room temperature to obtain PLA vacuum-formed cup lid product. The samples are tested for densities, cup lid diameter and temperature resistance are tested and the results are as shown in Table 2. After carbon dioxide treatment, the densities of the samples are hardly changed, and the appearance and morphology of the samples are not apparently changed. The cup lid diameter is changed by 1.40%-2.06% due to shrinkage as compared with the preforms of the cup lid, and the relative standard deviation is 0.16%-0.39%, but all the cup lids have a temperature resistance above 100° C.

### Example 3

PLA vacuum-formed cup lid preform with a formula composition No. 1 is placed in a mold container at 55° C., carbon dioxide is injected into the container at a pressure of 4.5 MPa, the preform is soaked at constant temperature and pressure for 3, 10, 20, 40 minutes respectively, rapid pressure release at a speed of 16 MPa/s is performed, the mold is opened to take out the sample, and the sample is cooled at room temperature to obtain PLA vacuum-formed cup lid product. The sample is tested for density, cup lid diameter and temperature resistance are tested and the results are as shown in Table 2. After carbon dioxide treatment, the density of the sample is hardly changed, and the appearance and morphology of the sample are not apparently changed. The cup lid diameter is changed by 1.96%-2.19% due to shrinkage as compared with the cup lid preform, and the relative standard deviation is 0.29%-0.38%, but all the cup lids have a temperature resistance above 100° C.

### Example 4

PLA vacuum-formed cup lid preform with a formula composition No. 3 is placed in a mold container at 35° C., carbon dioxide is injected into the container at a pressure of 4 MPa and 7 MPa respectively, the preform is soaked at constant temperature and pressure for 20 minutes, rapid pressure release at a speed of 14 MPa/s and 24 MPa/s respectively is performed, the mold is opened to take out the sample, and the sample is cooled at room temperature to obtain PLA vacuum-formed cup lid product. The sample is tested for density, cup lid diameter and temperature resistance are tested and the results are as shown in Table 2. After carbon dioxide treatment, the density of the sample is hardly changed, and the appearance and morphology of the sample are not apparently changed. The cup lid diameter is changed by 2.05%-2.16% due to shrinkage as compared with the cup lid preform, and the relative standard deviation is 0.32%-0.20%, but all the cup lids have a temperature resistance above 100° C.

Comparative Example 1, PLA vacuum-formed cup lid preforms with formula composition Nos. 1-3 are placed on a thermal drying tunnel production line at a starting temperature of 70° C. and an end temperature of 85° C., and the samples are retained for 6 minutes, after which all the samples are severely deformed. Heat treatment in an oven in a laboratory is used instead, samples are deformed under different heat treatment temperature and constant temperature ventilation for a certain time. Even when the temperature is set to be 70° C. and it is processed for 5 minutes, the cup lid samples are deformed or even severely deformed. Since the temperature resistance of the cup lid preform is only 55° C., 70° C. is only above the softening temperature (i.e., glass transition temperature) of the cup lid preform, while the cold crystallization peak of the cup lid preform is about 99° C., the samples are heat-treated in an oven at 70° C., except for the sample deformation (to eliminate the residual internal stress in the vacuum-formed samples), and crystallization cannot be completed, and thus the final product is also not thermoresistant.

It can be seen therefrom that a PLA vacuum-formed cup lid which is completely non-deformed and thermoresistant after crystallization cannot be obtained only by processing with a thermal drying tunnel or heat treatment in an oven.

### Example 5

PLA vacuum-formed dish preform with a formula composition No. 3 is placed in a mold container at 65° C., carbon dioxide is injected into the container at a pressure of 10 MPa, the preform is soaked at constant temperature and pressure for 20 minutes, rapid pressure release at a speed of 34 MPa/s is performed, the mold is opened to take out the sample, and the sample is cooled at room temperature to obtain PLA vacuum-formed dish product. The sample is tested for density and temperature resistance and the results are as shown in Table 3. After carbon dioxide treatment, the density of the sample is reduced by 20.4% as compared with the density of the preform, and the temperature resistance is above 100° C.

### Example 6

PLA vacuum-formed dish preform with a formula composition No. 3 is placed in a mold container at 75° C., carbon dioxide is injected into the container at a pressure of 13 MPa, the preform is soaked at constant temperature and pressure for 20 minutes, rapid pressure release at a speed of 44 MPa/s is performed, the mold is opened to take out the sample, and the sample is cooled at room temperature to obtain PLA vacuum-formed dish product. The sample is tested for density and temperature resistance and the results are as shown in Table 3. After carbon dioxide treatment, the density of the sample is reduced by 31.6% as compared with the density of the preform, and the temperature resistance is above 100° C.

### Example 7

PLA vacuum-formed dish preform with a formula composition No. 3 is placed in a mold container at 85° C., carbon dioxide is injected into the container at a pressure of 10 MPa, the preform is soaked at constant temperature and pressure for 20 minutes, rapid pressure release at a speed of 34 MPa/s is performed, the mold is opened to take out the sample, and the sample is cooled at room temperature to obtain PLA vacuum-formed dish product. The sample is tested for density and temperature resistance and the results are as shown in Table 3. After carbon dioxide treatment, the density of the sample is reduced by 35.2% as compared with the density of the preform, and the temperature resistance is above 100° C.

### Example 8

PLA vacuum-formed dish preform with a formula composition No. 3 is placed in a mold container at 95° C., carbon dioxide is injected into the container at a pressure of 12 MPa, the preform is soaked at constant temperature and pressure for 6 minutes, rapid pressure release at a speed of 41 MPa/s is performed, the mold is opened to take out the sample, and the sample is cooled at room temperature to obtain PLA vacuum-formed dish product. The sample is tested for density and temperature resistance and the results are as shown in Table 3. After carbon dioxide treatment, the density of the sample is reduced by 41.3% as compared with the density of the preform, and the temperature resistance is above 100° C.

After carbon dioxide treatment, PLA is crystallized, and a microporous foaming structure is generated inside PLA vacuum-formed dish, which provides PLA vacuum-formed dish with a valuable function of temperature resistance (above 100° C.) and heat insulation. At the same time, the density of the product is reduced significantly.

1. A method for preparing a thermoresistant PLA vacuum-formed tableware, comprising the following steps:
(1) preparing a sheet from a raw material of the vacuum-formed PLA tableware via extrusion using an extruder, and preparing a tableware preform from the sheet via vacuum forming, the tableware preform comprising PLA that is not completely crystallized; and
(2) subjecting the tableware preform to carbon dioxide soaking treatment at constant temperature and pressure to crystallize the uncrystallized PLA in the tableware preform, so as to obtain a PLA tableware product with a temperature resistance above 100° C.;
wherein, a method of the carbon dioxide soaking treatment in step (2) comprises: placing PLA tableware preform in a temperature-adjustable closed container with high temperature and high-pressure resistance, injecting the carbon dioxide into the closed container, and soaking at a constant temperature and under retained pressure;
in step (2), a pressure retaining temperature is 35° C.-100° C., a pressure retaining pressure is 4-13 MPa, a pressure retaining time is 1-40 minutes, and a pressure release speed is 5-45 MPa/s; and
the carbon dioxide is a supercritical carbon dioxide fluid or a subcritical carbon dioxide fluid.

2. The method for preparing the thermoresistant PLA vacuum-formed tableware according to claim 1, wherein a thickness of the sheet in step (1) is 0.35-1 mm, and thickness of the tableware preform is 0.3-0.9 mm.

3. The method for preparing the thermoresistant PLA vacuum-formed tableware according to claim 1, wherein the vacuum-formed tableware is a cup lid, the pressure retaining temperature is 35° C.-65° C., the pressure retaining pressure is 4-7 MPa, and a density of a cup lid product relative to the preform is changed by +1% or below; a shrinkage of the cup lid product is constant with a relative standard deviation of 0.5% or below when a sample diameter is below 100 mm, and the relative standard deviation is 1% or below when the sample diameter is 100 mm or above.

4. The method for preparing the thermoresistant PLA vacuum-formed tableware according to claim 1, wherein the vacuum-formed tableware is a dish, the pressure retaining temperature is 65° C.-95° C., the pressure retaining pressure is 10-13 MPa, and a density of a dish product relative to the preform is reduced by 20%-50%.

5. The method for preparing the thermoresistant PLA vacuum-formed tableware according to claim 1, wherein the raw material for PLA vacuum-formed tableware in step (1) comprises the following components by mass:
45%-80% of a major material;
10%-40% of an auxiliary material;
10%-35% of a filler; and
0-5% of a modifier;
wherein the major material is PLA;
the auxiliary material is PBAT, PBS or a blend of PBAT and PBS;
the filler is selected from any one or a combination of more than one of talc, calcium carbonate, silica, bentonite, coffee grounds, and bamboo powder; and
the modifier is selected from any one or a combination of more than one of a nucleating agent, an antioxidant, an antistatic agent, an antibacterial agent, a color masterbatch, a compatibilizer, a toughening agent, a lubricant, a release agent, a chain extender, or a crosslinking agent.

6. The method for preparing the thermoresistant PLA vacuum-formed tableware according to claim 5, wherein particles prepared by an extrusion blending and pelletizing process are used as the raw material for PLA vacuum-formed tableware.
